(19) United States
(12) Patent Application Publication
(10) Pub. No.: US 2026/0046970 A1
(43) Pub. Date: Feb. 12, 2026

(54) RLF RECOVERY FOR ANCHORED NETWORK NODE DEPLOYMENT

(71) Applicant: QUALCOMM Incorporated, San Diego, CA (US)

(72) Inventors: Naeem AKL, San Jose, CA (US); Ozcan OZTURK, San Diego, CA (US)

(21) Appl. No.: 19/292,815

(22) Filed: Aug. 6, 2025

Related U.S. Application Data
(60) Provisional application No. 63/680,555, filed on Aug. 7, 2024.

(51) Int. Cl. H04W 76/20; H04W 36/04; H04W 76/19

(52) U.S. Cl. CPC H04W 76/20; H04W 36/04; H04W 76/19

(57) ABSTRACT

Apparatus, methods, and computer program products for wireless communication are provided. An example method may include receiving, from a second network node, first identification information associated with a user equipment (UE) corresponding to a first cell, where the first cell is associated with the second network node and is a candidate serving cell for the UE. The example method may further include communicating with the UE based on a radio resource control (RRC) connection via the first cell. The example method may further include receiving, from the UE, a request to re-establish the RRC connection with the UE, where the request includes second identification information for the first cell. The example method may further include transmitting a message to the UE to re-establish the RRC connection with the UE based on a match between the first identification information and the second identification information.

### CROSS REFERENCE TO RELATED APPLICATION(S)

This application claims the benefit of and priority to U.S. Provisional Application Ser. No. 63/680,555, entitled “RLF RECOVERY FOR ANCHORED NETWORK NODE DEPLOYMENT” and filed on Aug. 7, 2024, which is expressly incorporated by reference herein in its entirety.

### TECHNICAL FIELD

The present disclosure relates generally to communication systems, and more particularly, to wireless communication systems with radio link failure (RLF) recovery.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network node are provided. The apparatus may include at least one memory and at least one processor coupled to the at least one memory. Based at least in part on information stored in the at least one memory, the at least one processor is configured to (e.g., cause the first network node to) receive, from a second network node, first identification information associated with a user equipment (UE) corresponding to a first cell, where the first cell is associated with the second network node and is a candidate serving cell for the UE. Based at least in part on information stored in the at least one memory, the at least one processor is configured to communicate with the UE based on a radio resource control (RRC) connection via the first cell. Based at least in part on information stored in the at least one memory, the at least one processor is configured to receive, from the UE, a request to re-establish the RRC connection with the UE, where the request includes second identification information for the first cell. Based at least in part on information stored in the at least one memory, the at least one processor is configured to transmit a message to the UE to re-establish the RRC connection with the UE based on a match between the first identification information and the second identification information.

In another aspect of the disclosure, a method, a computer-readable medium, and an apparatus at a second network node are provided. The apparatus may include at least one memory and at least one processor coupled to the at least one memory. Based at least in part on information stored in the at least one memory, the at least one processor is configured to (e.g., cause the second network node to) provide, to a first network node, first identification information associated with a UE corresponding to a first cell, where the first cell is associated with the second network node and is a candidate serving cell for the UE. Based at least in part on information stored in the at least one memory, the at least one processor is configured to forward at least one packet for an RRC connection between the first network node and the UE via the first cell. Based at least in part on information stored in the at least one memory, the at least one processor is configured to receive, from the first network node, a request to retrieve a context for the UE to re-establish the RRC connection with the UE, where the context includes second identification information for the first cell. Based at least in part on information stored in the at least one memory, the at least one processor is configured to provide an indication for a presence of the context for the UE to the first network node.

In another aspect of the disclosure, a method, a computer-readable medium, and an apparatus at a first network node are provided. The apparatus may include at least one memory and at least one processor coupled to the at least one memory. Based at least in part on information stored in the at least one memory, the at least one processor is configured to (e.g., cause the first network node to) communicate, with a second network node, first identification information associated with a UE corresponding to a first cell, where the first cell is associated with the second network node and is a candidate serving cell for the UE. Based at least in part on information stored in the at least one memory, the at least one processor is configured to communicate with the UE based on an RRC connection via the first cell. Based at least in part on information stored in the at least one memory, the at least one processor is configured to receive, from the second network node, a request to retrieve a context for the UE to re-establish the RRC connection with the UE, where the context includes second identification information for the first cell. Based at least in part on information stored in the at least one memory, the at least one processor is configured to provide the context for the UE to the second network node based on identifying a match between the first identification information and the second identification information.

In another aspect of the disclosure, a method, a computer-readable medium, and an apparatus at a second network node are provided. The apparatus may include at least one memory and at least one processor coupled to the at least one memory. Based at least in part on information stored in the at least one memory, the at least one processor is configured to (e.g., cause the second network node to) forward at least one packet associated with an RRC connection between a UE and a first network node via a first cell associated with the second network node based at least in part on first identification information for the UE corresponding to the first cell. Based at least in part on information stored in the at least one memory, the at least one processor is configured to receive, from the UE, a request to re-establish the RRC connection with the UE, where the request includes second identification information for the first cell. Based at least in part on information stored in the at least one memory, the at least one processor is configured to provide, to the first network node, a second request to retrieve a context for the UE to re-establish the RRC connection with the UE based on identifying a match between the first identification information and the second identification information.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and

an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of inter-network node cell switch, in accordance with various aspects of the present disclosure.

FIG. 5 is a diagram illustrating an example of inter-network node cell switch where packet data convergence protocol (PDCP) remains anchored on the original network node, in accordance with various aspects of the present disclosure.

FIG. 6 is a diagram illustrating an example of radio link failure recovery (RLF), in accordance with various aspects of the present disclosure.

FIG. 7 is a diagram illustrating different examples of RLF and recovery when PDCP and radio link control (RLC) of the UE are anchored on separate network nodes, in accordance with various aspects of the present disclosure.

FIG. 8 is a diagram illustrating an example of RLF and recovery when PDCP and are anchored on separate network nodes, where recovery occurs at the PDCP anchor, in accordance with various aspects of the present disclosure.

FIG. 9 is a diagram illustrating example communications between a first network node, a second network node, and a UE, where recovery occurs at the PDCP anchor, in accordance with various aspects of the present disclosure.

FIG. 10 is a diagram illustrating an example of RLF and recovery when PDCP and are anchored on separate network nodes, where recovery occurs at the RLC anchor, in accordance with various aspects of the present disclosure.

FIG. 11 is a diagram illustrating example communications between a first network node, a second network node, and a UE, where recovery occurs at the RLC anchor, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

In some wireless communication systems, instead of switching both radio link control (RLC) and packet data convergence protocol (PDCP) for inter-network node cell switch, the PDCP for a UE may remain anchored at the original network node and the RLC for the UE may be switched. In other words, the new cell at the new network node may serve as a cell that forwards packets between the UE and the original network node while the PDCP anchor remains at the original network node, and the RRC connection remains between the UE and the original network node. As a result of switching the RLC but not switching the PDCP to a different network node, there may be a number of different implications. As a first example, because the UE context is not relocated, the security update may not be used. As a second example, the PDCP may not be re-established because the PDCP anchor is not switched from a first network node to a second network node. As a third example, UP data interruption may be small due to not switching the PDCP. As a fourth example, there may be no path switch towards the CN (e.g., the original network node is still used). Aspects provided herein may provide mechanisms for performing radio link failure recovery at the original RLC anchor network node or the original PDCP anchor network node when the UE was originally anchored at separate network nodes for PDCP and RLC.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

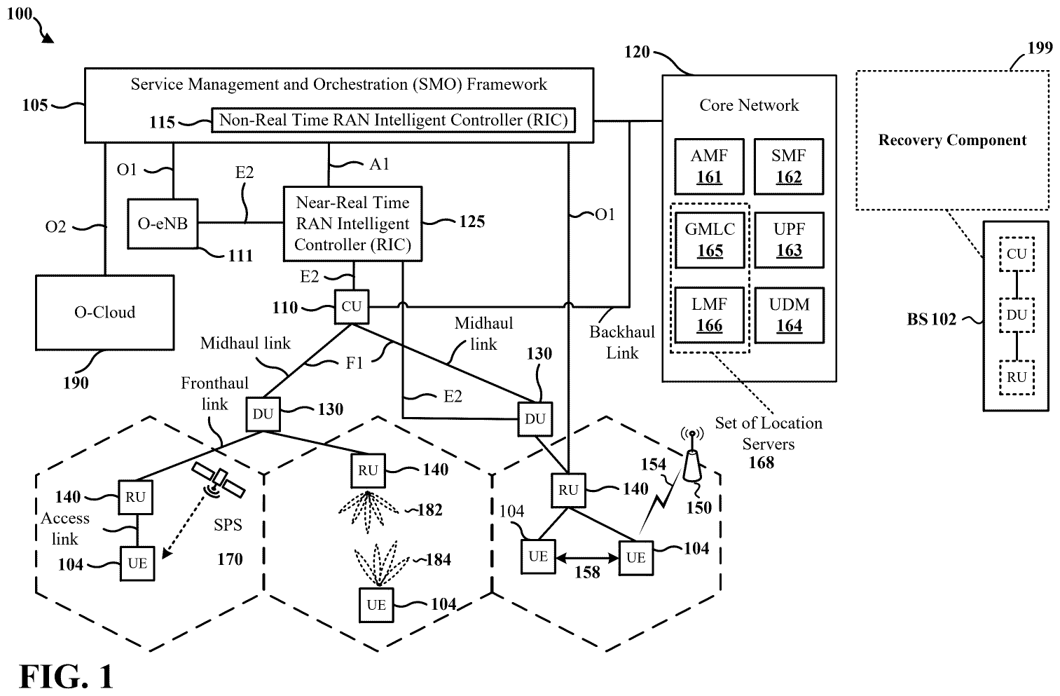

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-NB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GH2), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the base station 102 may include a recovery component 199. In some aspects, the recovery component 199 may be configured to receive, from a second network node, first identification information associated with a UE corresponding to a first cell, where the first cell is associated with the second network node and is a candidate serving cell for the UE. In some aspects, the recovery component 199 may be configured to communicate with the UE based on an RRC connection via the first cell. In some aspects, the recovery component 199 may be configured to receive, from the UE, a request to re-establish the RRC connection with the UE, where the request includes second identification information for the first cell. In some aspects, the recovery component 199 may be configured to transmit a message to the UE to re-establish the RRC connection with the UE based on a match between the first identification information and the second identification information.

In some aspects, the recovery component 199 may be configured to provide, to a first network node, first identification information associated with a UE corresponding to a first cell, where the first cell is associated with the second network node and is a candidate serving cell for the UE. In some aspects, the recovery component 199 may be configured to forward at least one packet for an RRC connection between the first network node and the UE via the first cell. In some aspects, the recovery component 199 may be configured to receive, from the first network node, a request to retrieve a context for the UE to re-establish the RRC connection with the UE, where the context includes second identification information for the first cell. In some aspects, the recovery component 199 may be configured to provide an indication for a presence of the context for the UE to the first network node.

In some aspects, the recovery component 199 may be configured to communicate, with a second network node, first identification information associated with a UE corresponding to a first cell, where the first cell is associated with the second network node and is a candidate serving cell for the UE. In some aspects, the recovery component 199 may be configured to communicate with the UE based on an RRC connection via the first cell. In some aspects, the recovery component 199 may be configured to receive, from the second network node, a request to retrieve a context for the UE to re-establish the RRC connection with the UE, where the context includes second identification information for the first cell. In some aspects, the recovery component 199 may be configured to provide the context for the UE to the second network node based on identifying a match between the first identification information and the second identification information.

In some aspects, the recovery component 199 may be configured to forward at least one packet associated with an RRC connection between a UE and a first network node via a first cell associated with the second network node based at least in part on first identification information for the UE corresponding to the first cell. In some aspects, the recovery component 199 may be configured to receive, from the UE, a request to re-establish the RRC connection with the UE, where the request includes second identification information for the first cell. In some aspects, the recovery component 199 may be configured to provide, to the first network node, a second request to retrieve a context for the UE to re-establish the RRC connection with the UE based on identifying a match between the first identification information and the second identification information.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

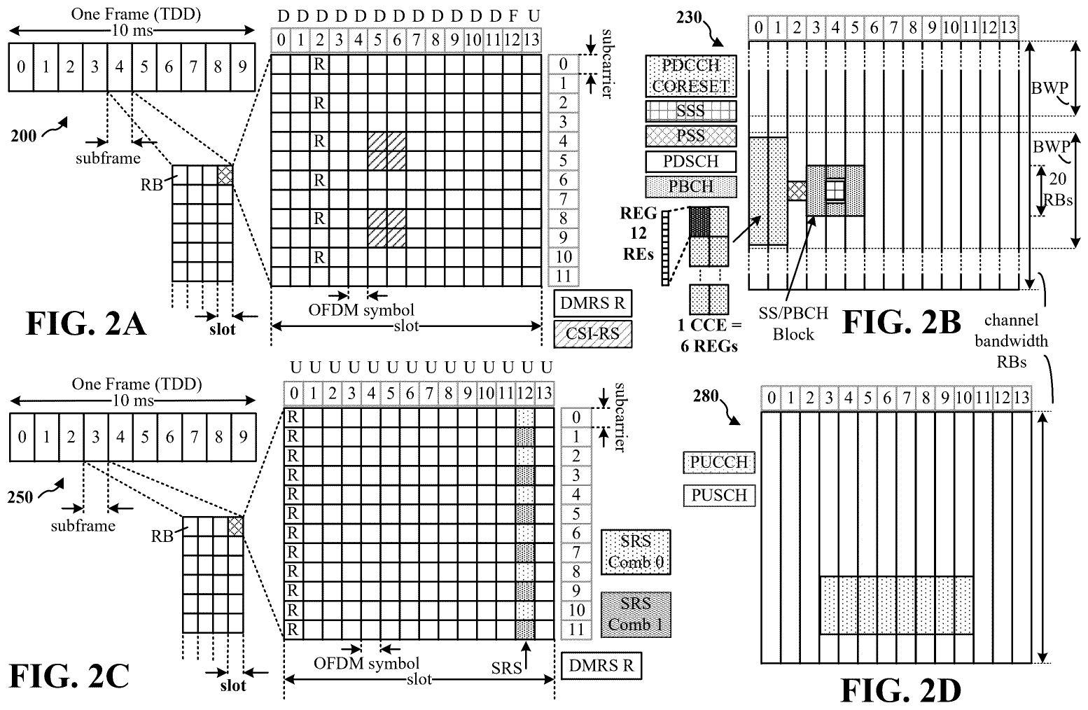

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

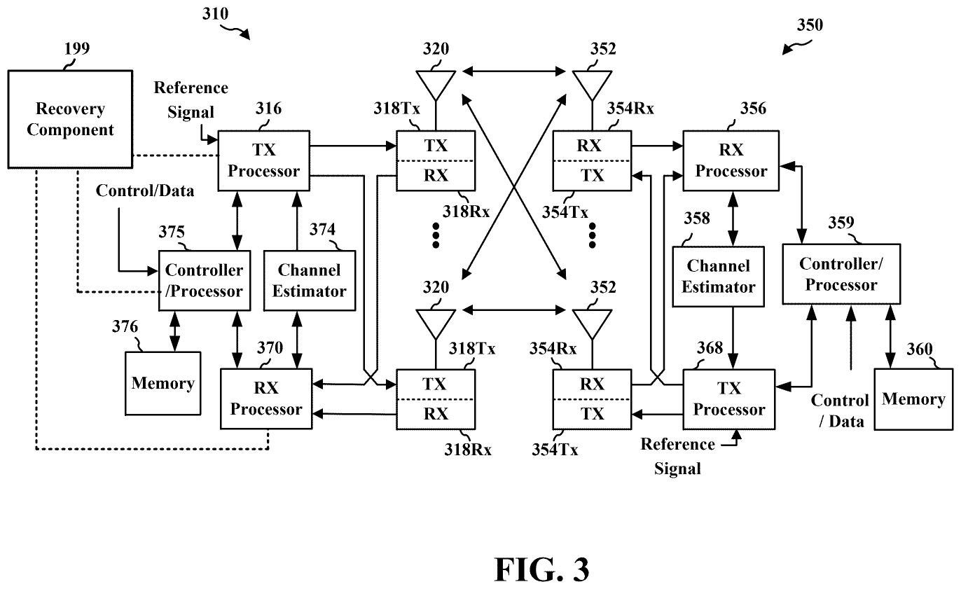

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with recovery component 199 of FIG. 1.

A network may be in communication with a UE based on one or more beams (spatial filters). For example, a base station of the network may transmit a beamformed signal to a UE in one or more directions that correspond with one or more beams. The base station and the UE may perform beam training to determine the best receive and transmit beam directions for the base station and the UE.

In response to different conditions, beams may be switched. For example, a TCI state change may be transmitted by a base station so that the UE may switch to a new beam for the TCI state. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. A TCI state may include quasi-co-location (QCL) information that the UE can use to derive timing/frequency error and/or transmission/reception spatial filtering for transmitting/receiving a signal.

Different procedures for managing and controlling beams may be collectively referred to as “beam management.” The process of selecting a beam to switch to for data channels or control channels may be referred to as “beam selection.” In some wireless communication systems, beam selection for data channels or control channels may be limited to beams within the same physical cell identifier (ID) (PCI). A PCI may be associated with a TRP. By way of example, a UE may encounter two types of mobility—cell-level mobility and beam-level mobility (which may be beam-based mobility). For cell-level mobility, a UE may experience an inter-base station handover. In some wireless communication systems, for beam-level mobility, as previously explained, switching of beams may occur within the same base station.

In some wireless communication systems, inter-cell beam management may be based on beam-based mobility where the indicated beam may be from a TRP with different PCI with regard to the serving cell. Benefits of inter-cell beam management based on beam-based mobility may include more robustness against blocking, more opportunities for higher rank for subscriber data management (SDM) across different cells, and in general more efficient communication between a UE and the network. As an example, inter-cell beam management based on beam-based mobility may be facilitated by L1 and/or L2 (L1/L2) signaling, such as UE-dedicated channels/RSs, which may be associated with a switch to a TRP with different PCI according to downlink control information (DCI) or medium access control (MAC) control element (MAC-CE) based unified TCI update. As used herein, such mobility may be referred to as L1/L2 mobility (lower-layer triggered mobility (LTM)). In some aspects, inter-CU Layer 2 mobility may be referred to as LTM. In some aspects, the network may configure a set of cells for L1/L2 mobility or LTM. The set of cells for L1/L2 mobility may be referred to as L1/L2 mobility configured cell set or an LTM configured cell set. A subset of the L1/L2 mobility configured cell set may be activated (e.g., with L1 or L2 control signaling) and may be referred to as an L1/L2 mobility activated cell set (which may also be referred to as an L1/L2 activated mobility cell set or LTM activated cell set). The subset of the L1/L2 mobility configured cell set that is not activated or that is indicated to be deactivated may be referred to as an L1/L2 mobility deactivated cell set or a deactivated L1/L2 mobility cell set or an LTM deactivated cell set. The L1/L2 mobility activated cell set may be a group of cells in the L1/L2 mobility configured cell set that are activated and may be readily used for data and control transfer. The L1/L2 mobility deactivated cell set (which may be an L1/L2 mobility candidate cell set) may be a group of cells in the configured set that is configured for the UE yet deactivated (e.g., not used for data/control transfer until activated) and may be activated by L1/L2 signaling. Once activated, a deactivated cell may be used for data and control transfer. The configuration and maintenance of multiple candidate cells may allow for a quicker application of configurations for the candidate cells, and the activated set of cells may provide for dynamic switching among the candidate serving cells (e.g., including a special cell (SpCell) and SCell) based on L1 or L2 signaling.

The procedures of L1/L2 based inter-cell mobility or LTM are applicable to many scenarios. These scenarios may include standalone CA and NR-DC cases with serving cell changing within one CG, intra-DU cases and intra-CU inter-DU cases (applicable for standalone and CA, with no new RAN interface expected), intra-frequency and inter-frequency cases, FR1 and FR2 cases. In these scenarios, the source and target cells may be synchronized or non-synchronized.

For mobility management of the activated cell set, L1/L2 signaling may be used to activate/deactivate cells in the L1/L2 mobility configured cell set and to select beams within the activated cells (of the activated cell set). As the UE moves, cells from the L1/L2 mobility configured cell set may be deactivated and activated by L1/L2 signaling based on signal quality (e.g., based on measurements), loading, or the like. Example measurements may include cell coverage measurements represented by Radio Signal Received Power (RSRP), and quality represented by Radio Signal Received Quality (RSRQ), or other measurements that the UE performs on signals from the base station. In some aspects, the measurements may be L1 measurements, such as one or more of an RSRP, an RSRQ, a received signal strength indicator (RSSI), or a signal-to-interference plus noise ratio (SINR) measurement of various signals, such as an SSB, a PSS, an SSS, a broadcast channel (BCH), a DM-RS, CSI-RS, or the like.

In some aspects, all cells in the L1/L2 mobility configured cell set may belong to the same DU and the cells may be on the same or different carrier frequencies. Cells in the L1/L2 mobility configured cell set may cover a mobility area. There may be inter-cell CU LTM. In a first case, the CU may be acting as master node (MN) when dual-connectivity (DC) is not configured. In a second case, the DC may be configured and CU may be acting as secondary node (SN) and master cell group (MCG) may be unchanged. In a third case, DC may be configured and CU may be acting as MN, and SCG may be unchanged or released. There may be support for subsequent LTM mobility procedures that avoids RRC configuration between cell switches.

As part of LTM, the network node (e.g., gNB) may be switched. In some aspects, the switch may be referred to as an inter-gNB cell switch. For example, a UE may switch from a first cell at a first network node to a second cell at a second network node. As an example, cell switch may occur due to a failure in the RRC connection. In some wireless communication systems, both RLC and PDCP may be relocated for control plane (CP) and user plane (UP). As a result of switching both RLC and PDCP for the UE to a different network node, there may be a number of different implications. As a first example, a security update may be used because the UE context is relocated. As a second example, the PDCP for the UE may be re-established because the PDCP anchor (an anchor may be a point in the network that manages handovers and provides continuity of service as the UE moves) is switched from a first network node to a second network node. As a third example, the UP data interruption for the UE may be large due to the switch of both the RLC and the PDCP. As a fourth example, depending on the security update, there may be an impact at the core network (CN), e.g., causing additional signaling overhead, higher complexity, and/or additional updates for the security update. As a fifth example, dynamic signaling between the access network and the CN may be used for each cell switch that involves switching a network node. As a particular example for a UE anchored at a DU, the DU may manage user plane data or radio link control for the DU and the UE's radio connection may be physically facilitated by the DU. As a particular example for a UE anchored at a CU, the CU may manage UE's session (e.g., control plane or user plane) and may hold UE context and manage session setup and policy.

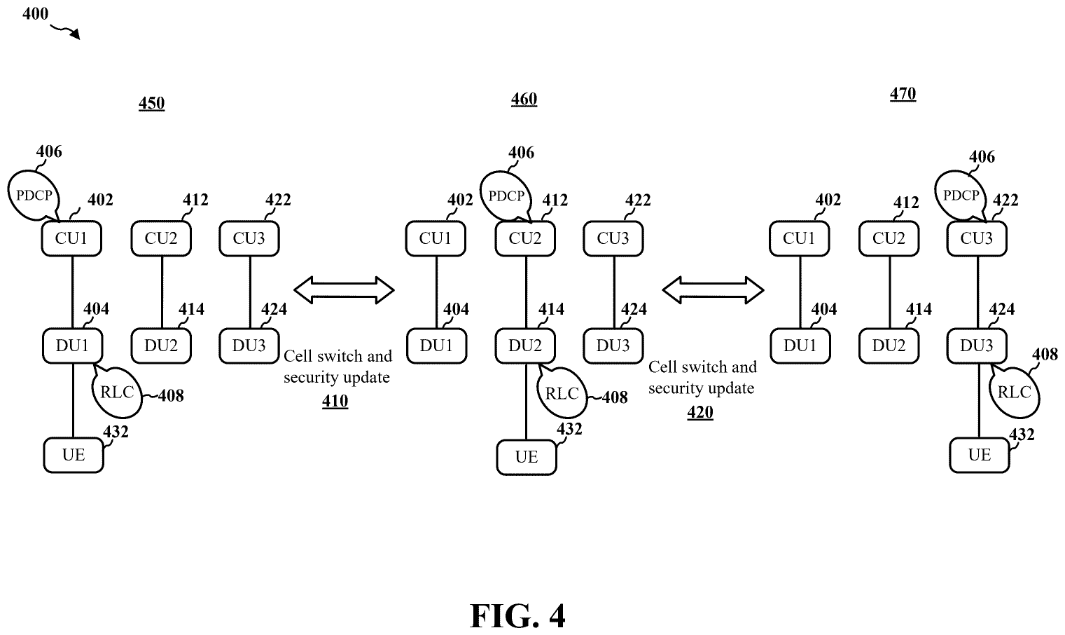

FIG. 4 is a diagram 400 illustrating an example of inter-network node cell switch (e.g., which may be referred to as an inter-gNB cell switch in some examples), in accordance with various aspects of the present disclosure. As illustrated in FIG. 4, there may be a UE 432, a first network node that includes CU1 402 and DU1 404, a second network node that includes CU2 412 and DU2 414, and a third network node that includes CU3 422 and DU3 424. In a first scenario 450 (e.g., at a first time), the UE 432 may be served by a first cell at a first network node, and the PDCP 406 may be anchored at CU1 402 of the first network node and RLC 408 may be anchored at the DU1 404 of the first network node. Upon a cell switch 410 (and associated security update), the UE 432 may switch to being served by a cell at the second network node. Therefore, in a second scenario 460 (e.g., at a second time), the PDCP 406 for the UE may be anchored at CU2 412 of the second network node and the RLC 408 for the UE may be anchored at the DU2 424 of the second network node. Upon another cell switch 420 (and associated security update), the UE 432 may switch to being served by a cell at the third network node. Therefore, in a third scenario 470 (e.g., at a third time), the PDCP 406 for the UE may be anchored at CU3 422 of the third network node and the RLC 408 for the UE may be anchored at the DU3 434 of the third network node.

In some wireless communication systems, instead of switching both RLC and PDCP for inter-network node cell switches, the PDCP for the UE may remain anchored at the original network node and the RLC for the UE may be switched to the new network node. In other words, the new cell at the new network node may serve as a cell that forwards packets between the UE and the original network node while the PDCP anchor for the UE remains at the original network node, and the RRC connection may remain between the UE and the original network node. As a result of switching the RLC but not switching the PDCP to a different network node, there may be a number of different implications. As a first example, because UE context is not relocated, the security update may not be used (e.g., communication may continue between the network and the UE without a security update). As a second example, the PDCP may be not re-established because the PDCP anchor is not switched from a first network node to a second network node. As a third example, UP data interruption for the UE may be reduced because the PDCP is not switched to the new network node. As a fourth example, there may be no path switch towards the CN (original network node is still used).

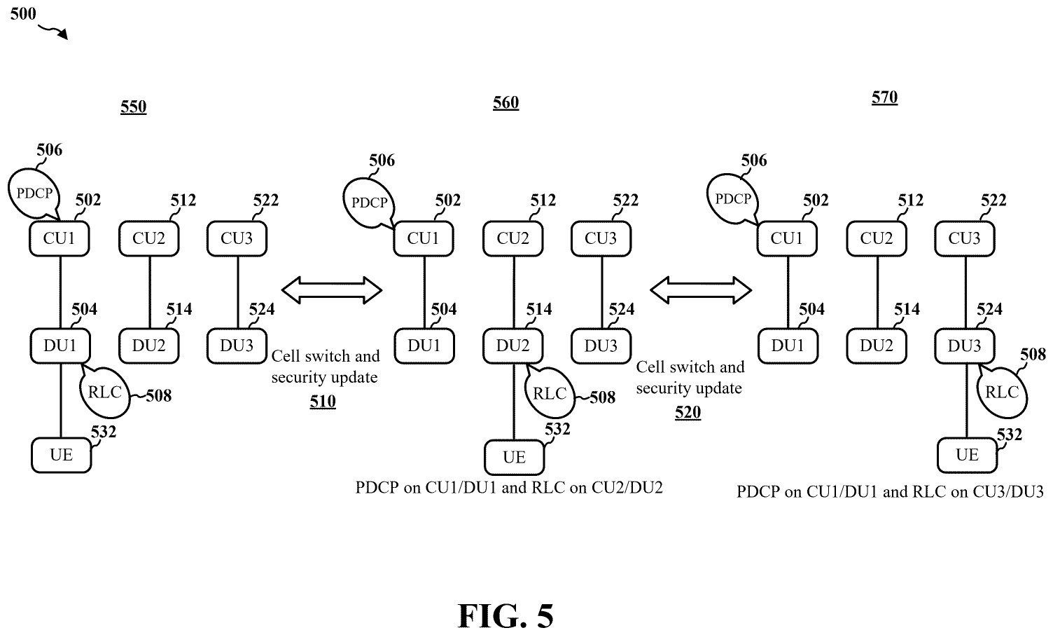

FIG. 5 is a diagram 500 illustrating an example of an inter-network node cell switch where the PDCP remains anchored at the original network node, in accordance with various aspects of the present disclosure. As illustrated in FIG. 5, there may be a UE 532, a first network node that includes CU1 502 and DU1 504, a second network node that includes CU2 512 and DU2 514, and a third network node that includes CU3 522 and DU3 524. In a first scenario 550 (e.g., at a first time), the UE is served by a first cell at the first network node, and the PDCP 506 for the UE may be anchored at CU1 502 of the first network node and the RLC 508 for the UE may be anchored at the DU1 504 of the first network node. Upon a cell switch 510 (and associated security update), the UE 532 may switch to being served by a second cell at the second network node. Therefore, in a second scenario 560 (e.g., at a second time), the PDCP 406 for the UE may remain anchored at CU1 502 of the first network node and the RLC 408 for the UE may be switched to be anchored the DU2 524 of the second network node. Upon another cell switch 520 (and associated security update), the UE 532 may switch to being served by a third cell at the third network node. Therefore, in a third scenario 570 (e.g., at a third time), the PDCP 406 for the UE may remain anchored at CU1 502 of the first network node, and the RLC 508 for the UE may be anchored at the DU3 534 of the third network node.

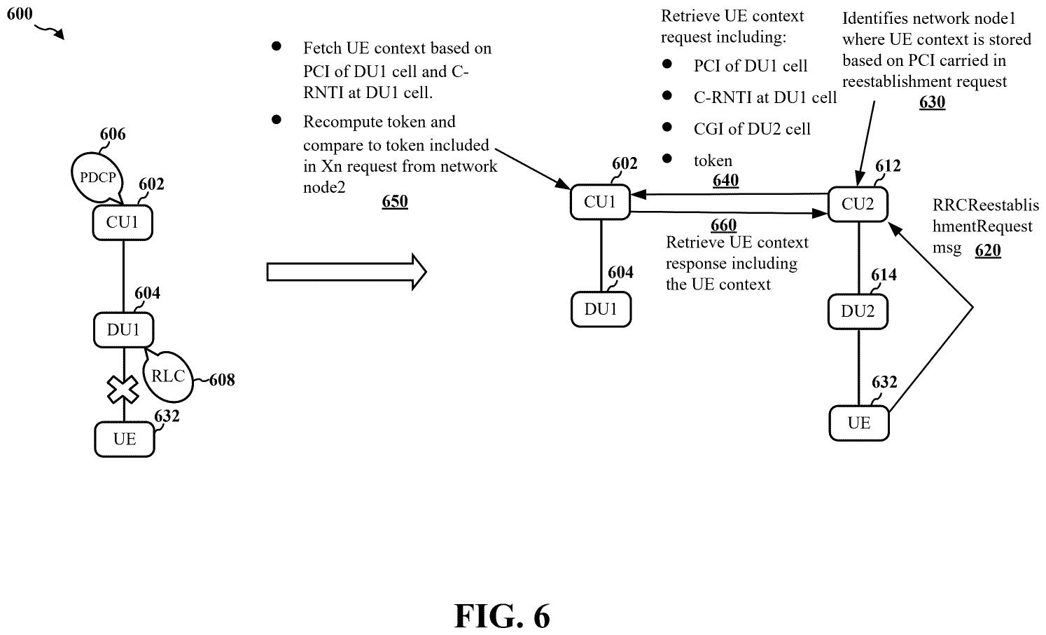

FIG. 6 is a diagram 600 illustrating an example of RLF recovery in which the PDCP and the RLC for the UE are anchored in the same network node (e.g., a same gNB) prior to the RLF. As illustrated in FIG. 6, when RLF occurs, a UE 632 may have PDCP 606 anchored at CU1 602 of a first network node and RLC 608 anchored at DU1 604 of the same first network node. To recover the radio link, the UE 632 may perform cell switch. The UE 632 may transmit an RRC re-establishment request message 620 (e.g., represented by information element (IE) RRCReestablishmentRequest msg) to a CU2 612 of a second network node. The RRC re-establishment request message 620 may include identity information of the UE (e.g., represented by IE ReestabUE-Identity) which may include one or more of: cell-radio network temporary identifier (C-RNTI) associated with a cell of the DU1 604 and the UE 632, PCI of the DU1 604 (e.g., represented by IE physCellId), a token (e.g., a short message authentication code-integrity (shortMAC-I) token) computed using PCI of the DU1 604, the C-RNTI associated with the cell of the DU1 604 and the UE 632, and a cell global identity (CGI) of a cell of the DU2 614. A ShortMAC-I token may be a token used for integrity protection of the message. The ShortMAC-I token may be generated by applying a cryptographic function to the message content along with a secret key shared between the UE and the network. The message may be verified by recalculating the ShortMAC-I using the same cryptographic function and key. A C-RNTI may be a type of RNTI used for identifying a UE at a specific cell. A CGI may be an identifier that identifies a cell in a public land mobile network (PLMN). The ShortMAC-I token may be a lightweight integrity token for validation of radio resource control messages where the network can confirm the validity of the ShortMAC-I token upon receiving an RRC resume/RRC re-establishment request or a different type of message from the UE. The ShortMAC-I token may be considered to be part of the UE's context.

Upon receiving the RRC re-establishment request message 620, at 630, the CU2 612 may identify the first network node where the UE context is stored based on the PCI of a cell of DU1 604 included in the RRC re-establishment request message 620. The CU2 612 may then transmit a retrieve UE context request 640, which may include the PCI of the cell of DU1 604 included in the RRC re-establishment request message 620, the C-RNTI associated with the cell of the DU1 604 and the UE 632, the CGI of the cell of the DU2 614, and the token, to the CU1 602 of the first network node. As used herein, the terms “retrieve UE context request,” “request for retrieval of a context for the UE,” “retrieve UE context request message,” “request to retrieve UE context,” and “request to retrieve a context,” may be used interchangeably to refer to a request from one network node to another network node to retrieve a context for a particular UE. As used herein, “context” of a UE may refer to information stored in the network about a particular UE which may include one or more of: (1) identifiers such as C-RNTI, international mobile subscriber identity (IMSI), temporary mobile subscriber identity (TMSI), or the like, (2) security information such as encryption keys and integrity protection keys, (3) bearer information about the data bearers established for the UE and associated quality of service (QoS) parameters, (4) information of allocated radio resources, (5) location information of the UE, (6) information related to mobility state of the UE, and (7) information about active sessions, IP addresses, and connection states. As used herein, the term “cell ID” may refer to CGI, PCI, or a different type of cell ID.

Upon receiving the retrieve UE context request 640, the CU1 602 of the first network node may, at 650, fetch UE context of the UE 632 based on the PCI of the cell of DU1 604 included in the RRC re-establishment request message 620 and the C-RNTI associated with the cell of the DU1 604 and the UE 632. The CU1 602 of the first network node may also re-compute token and compare it to token included in the retrieve UE context request 640 from the CU2 612 of the second network node. Upon verifying that the tokens match, the CU1 602 of the first network node may transmit a retrieve UE context response 660 including the UE context of the UE 632 to the CU2 612 of the second network node, so that the CU2 612 of the second network node may re-establish connection RRC connection with the UE 632. As used herein, the term “establish RRC connection” may refer to initial establishment or re-establishment of an RRC connection. As used herein, the terms “retrieve UE context response,” and “response to the request to retrieve the context,” may be used interchangeably and refer to a response that includes the requested UE context to a request to retrieve UE context.

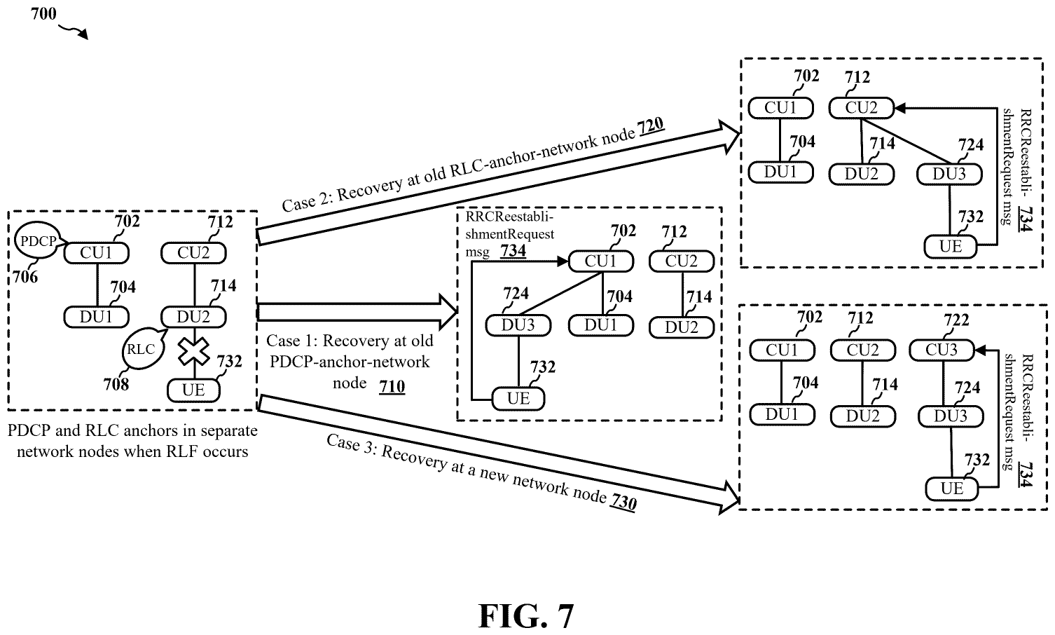

FIG. 6 illustrates a scenario for RLF recovery where the PDCP and RLC of the UE are anchored on the same network node. In contrast, FIG. 7 is a diagram 700 illustrating different examples of RLF and recovery when PDCP and RLC of the UE are anchored on separate network nodes, in accordance with various aspects of the present disclosure. As illustrated in FIG. 7, there may be a UE 732, a first network node that includes CU1 702 and DU1 704, a second network node that includes CU2 712 and DU2 714, and a third network node that includes CU3 722 and DU3 724. When the RLF occurs, the UE 732 may have its PDCP 706 anchored at CU1 702 of the first network node and its RLC 708 anchored at DU2 714 of the second network node. The RLF recovery may be performed differently in different cases. In a first case 710, the RLF recovery may be performed at the original PDCP anchor network node, e.g., the first network node. The UE 732 may connect to DU3 724 of the third network node, and may transmit an RRC re-establishment request 734 to the CU1 702 of the first network node. In a second case 720, the RLF recovery may be performed at the original RLC anchor network node, e.g., the second network node. The UE 732 may connect to DU3 724 of the third network node, and may transmit an RRC re-establishment request 734 to the CU2 712 of the second network node. In a third case 730, the RLF recovery may be performed at the new network node, e.g., the third network node. The UE 732 may connect to DU3 724 of the third network node, and may transmit an RRC re-establishment request 734 to the CU3 722 of the third network node. Aspects provided herein may provide mechanisms for performing the radio link failure recovery at the original (or prior) RLC anchor network node or the original (or prior) PDCP anchor network node (the first case 710 and the second case 720) when the UE was previously anchored at separate network nodes for PDCP and RLC.

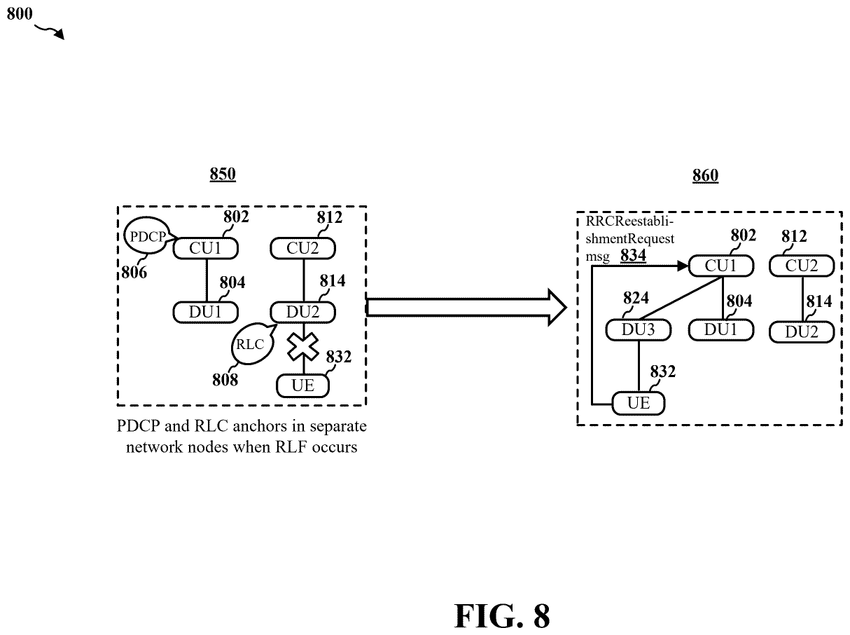

FIG. 8 is a diagram 800 illustrating an example of RLF and recovery when PDCP and RLC are anchored on separate network nodes, where recovery occurs at the PDCP anchor, in accordance with various aspects of the present disclosure. As illustrated in FIG. 8, there may be a UE 832, a first network node that includes CU1 802 and DU1 804, and a second network node that includes CU2 812 and DU2 814. When the RLF occurs for the UE at 850, the UE 832 may have its PDCP 806 anchored at CU1 802 of the first network node and its RLC 808 anchored at DU2 814 of the second network node. After the RLF occurs, at 860, the UE 832 may perform a random access procedure and establish communication with DU3 824 of a third network node, and transmit an RRC re-establishment message 834 (through the DU3 824) to the CU1 802 of the first network node. The RRC re-establishment message 834 may include a PCI of a first cell at the DU2 814, because the UE 832 was originally anchored at the DU2 814. Therefore, in some wireless communication systems, the CU1 802 of the first network node may transmit a retrieve UE context request to the second network node (e.g., CU2 812), even though the CU1 802 of the first network node already has the context for the UE 832. Aspects provided herein enable the first network node to identify that it stored the UE context despite receiving a re-establishment request message from the UE that indicates a prior serving cell that belongs to the second network node.

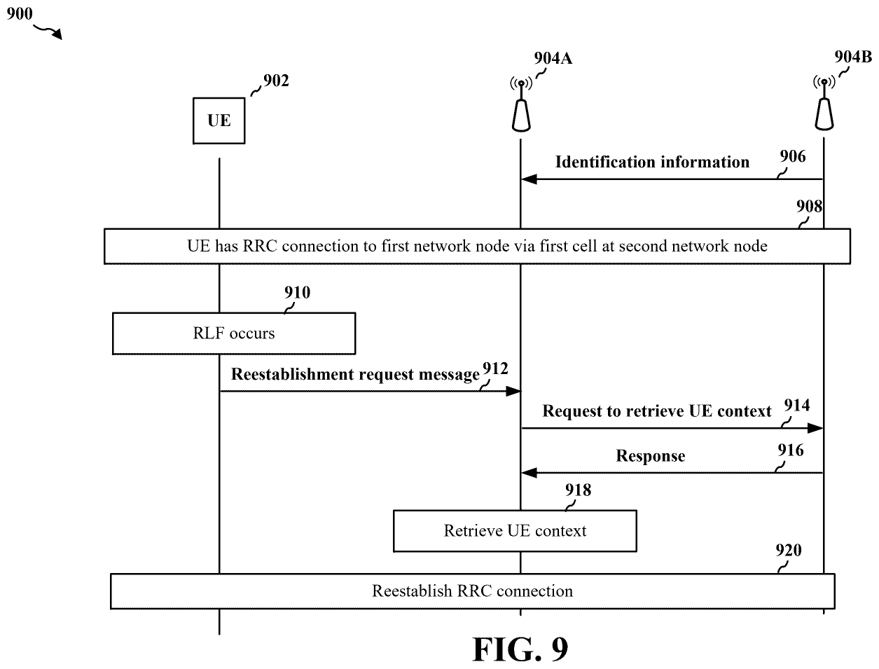

FIG. 9 is a diagram 900 illustrating example communications between a first network node 904A, a second network node 904B, and a UE 902, where recovery occurs at the PDCP anchor, in accordance with various aspects of the present disclosure. As illustrated in FIG. 9, the first network node 904A may receive, from the second network node 904B, identification information 906 associated with the UE 902. In some aspects, the identification information 906 may include a cell ID (e.g., CGI or PCI) of the first cell at the second network node 904B and the UE 902's C-RNTI at the first cell at the second network node 904B.

In some aspects, the identification information 906 may be received during preparation of a cell configuration of a DU at the second network node 904B for the UE 902, where the preparation is for the UE 902 to establish an RRC connection with the first network node 904A at 908 via a first cell at the second network node 904B, where the second network node 904B forwards packet(s) between the UE 902 and the first network node 904A. After the RRC connection is established at 908, the first network node 904A serves as a PDCP anchor for the UE 902 and the second network node 904B serves as an RLC anchor for the UE 902.

After the RRC connection is established at 908, the RLF may occur at 910 and the UE 902 may observe the RLF. In some aspects, based on observing the RLF at 910, the UE 902 may transmit an RRC re-establishment request message 912 to the first network node 904A after establishing communication with a cell at a third network node (e.g., after a RACH procedure). The third network node may forward communications for the UE 902. In some aspects, the RRC re-establishment request message 912 may include the cell ID (e.g., PCI or CGI) of the first cell at the second network node 904B, the UE 902's C-RNTI at the first cell at the second network node 904B, and a token. In some aspects, the token may be computed based on the cell ID (e.g., PCI) of the first cell at the second network node 904B, the UE 902's C-RNTI at the first cell at the second network node 904B, and a CGI of the cell at the third network node.

In some aspects, upon receiving the RRC re-establishment request message 912, which may include the cell ID (e.g., PCI or CGI) of the first cell at the second network node 904B, the UE 902's C-RNTI at the first cell at the second network node 904B, and a token, at 918, the first network node 904A may attempt to identify and retrieve the UE context within a local database based on the cell ID (e.g., PCI or CGI) of the first cell at the second network node 904B and the UE 902's C-RNTI at the first cell at the second network node 904B. In some aspects, if the first network node 904A found the UE context, the first network node 904A may re-establish RRC connection with the UE 902 without involving the second network node 904B.

In some aspects, instead of directly attempting to identify and retrieve the UE context within a local database based on the cell ID (e.g., PCI or CGI) of the first cell at the second network node 904B and the UE 902's C-RNTI at the first cell at the second network node 904B, upon receiving the RRC re-establishment request message 912, the first network node 904A may transmit a request to retrieve UE context 914 to the second network node 904B. The first network node 904A may transmit the request to retrieve UE context 914 to the second network node 904B based on (e.g., because) the RRC re-establishment request message 912 of the first cell at the second network node 904B and the UE 902's C-RNTI at the first cell at the second network node 904B. In some aspects, after transmitting the request to retrieve UE context 914 to the second network node 904B based on (e.g., because) the RRC re-establishment request message 912 of the first cell at the second network node 904B and the UE 902's C-RNTI at the first cell at the second network node 904B, the first network node may receive a response 916 from the second network node 904B. In some aspects, the response 916 may include an indication indicating that the UE context requested in the request to retrieve UE context 914 is at the first network node 904A. In some aspects, upon receiving the response 916, the first network node 904A may at 918, the first network node 904A may, at 918, attempt to identify and retrieve the UE context within a local database based on the cell ID (e.g., PCI or CGI) of the first cell at the second network node 904B and the UE 902's C-RNTI at the first cell at the second network node 904B. In some aspects, instead of waiting for the response 916, the first network node 904A may, after transmission of the RRC re-establishment request message 912 of the first cell, directly attempt to identify and retrieve the UE context within a local database based on the cell ID (e.g., PCI or CGI) of the first cell at the second network node 904B and the UE 902's C-RNTI at the first cell at the second network node 904B.

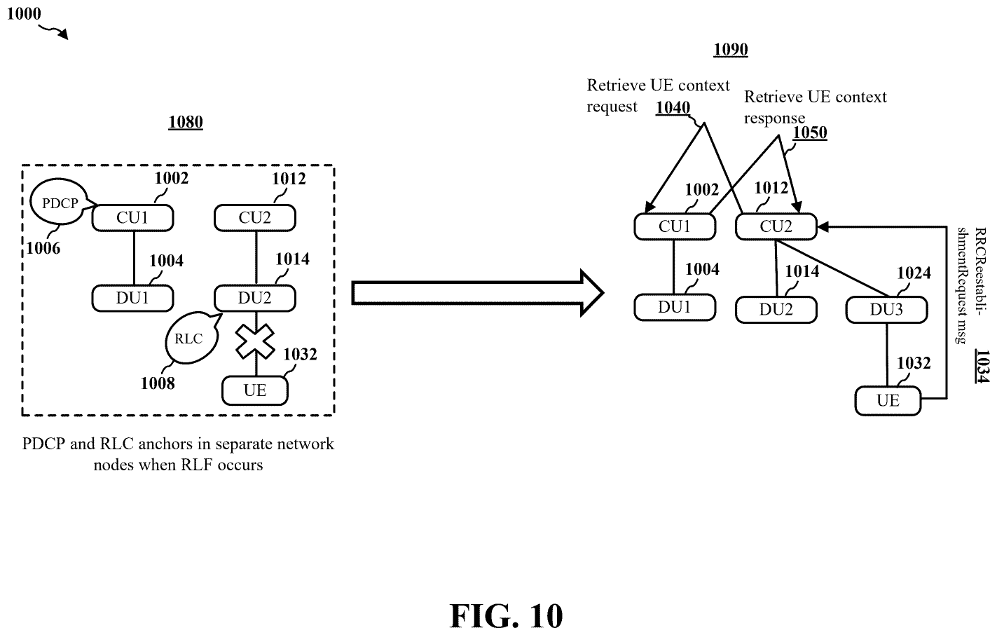

FIG. 10 is a diagram 1000 illustrating an example of RLF and recovery when PDCP and are anchored on separate network nodes, where recovery occurs at the RLC anchor, in accordance with various aspects of the present disclosure. As illustrated in FIG. 10, there may be a UE 1032, a first network node that includes CU1 1002 and DU1 1004, and a second network node that includes CU2 1012 and DU2 1014. When RLF occurs at 1080, the UE 1032 may have its PDCP 1006 anchored at CU1 1002 of the first network node and RLC 1008 anchored at DU2 1014 of the second network node. After the RLF occurs, at 1090, the UE 1032 may perform random access and establish communication with DU3 1024 of a third network node, and transmit an RRC re-establishment message 1034 (through the DU3 1024) to the CU1 1002 of the first network node. The RRC re-establishment message 1034 may include a PCI of a first cell at the DU2 1014 because the UE 1032 was originally anchored at the DU2 1014. However, in some wireless communication systems, the CU2 1012 of the second network node may not be able to locate the UE context, because the UE context is at the CU1 1002 of the first network node. Aspects provided herein enables the second network node to identify that the UE context is stored at the first network node and transmit a request to retrieve UE context 1040 to the first network node accordingly. Then the second network node may receive a retrieve UE context response 1050 from the CU1 1002 of the first network node and re-establish RRC connection with the UE accordingly.

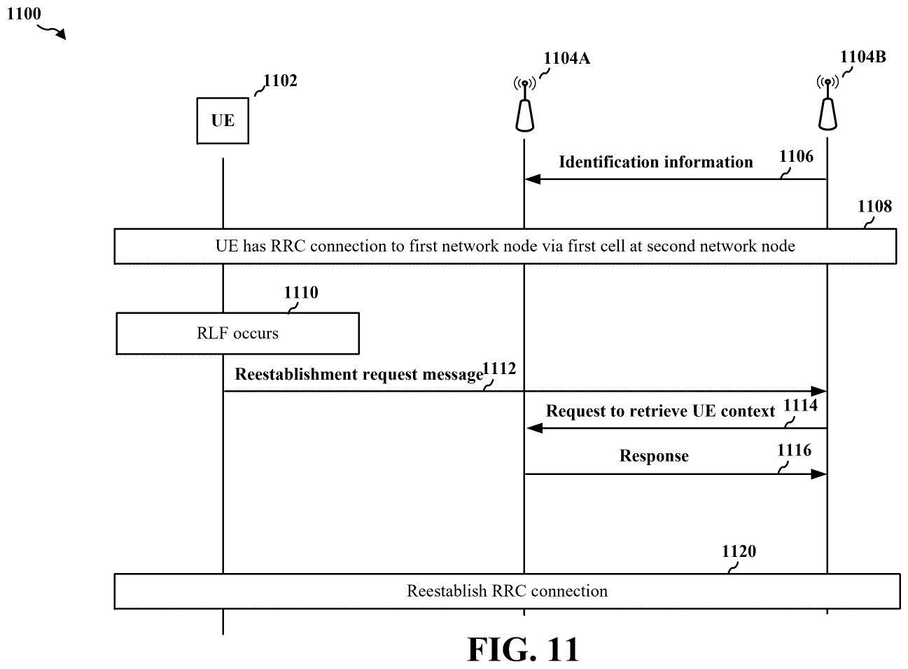

FIG. 11 is a diagram 1100 illustrating example communications between a first network node 1104A, a second network node 1104B, and a UE 1102, where recovery occurs at the RLC anchor, in accordance with various aspects of the present disclosure. As illustrated in FIG. 11, the first network node 1104A may receive, from the second network node 1104B, identification information 1106 associated with the UE 1102. In some aspects, the identification information 1106 may include a cell ID (e.g., CGI or PCI) of the first cell at the second network node 1104B and the UE 1102's C-RNTI at the first cell at the second network node 1104B.

In some aspects, the identification information 1106 may be received during preparation of a cell configuration of a DU at the second network node 1104B for the UE 1102, where the preparation is for the UE 1102 to establish an RRC connection with the first network node 1104A at 1108 via a first cell at the second network node 1104B, where the second network node 1104B forwards packet(s) between the UE 1102 and the first network node 1104A. After the RRC connection is established at 1108, the first network node 1104A serves as a PDCP anchor for the UE 1102 and the second network node 1104B serves as an RLC anchor for the UE 1102. During preparation of the cell configuration of a DU at the second network node 1104B for the UE 1102, the second network node 1104B may store a mapping between (1) the cell ID (e.g., CGI or PCI) of the first cell at the second network node 1104B and the UE 1102's C-RNTI at the first cell at the second network node 1104B, and (2) an ID of the first network node 1104A.

After the RRC connection is established at 1108, RLF may occur at 1110 and the UE 1102 may observe the RLF. In some aspects, based on observing the RLF at 1110, the UE 1102 may transmit an RRC re-establishment request message 1112 to the second network node 1104B after establishing communication with a cell at a third network node (e.g., after a random access/RACH procedure). The third network node may forward communications for the UE 1102. In some aspects, the RRC re-establishment request message 1112 may include the cell ID (e.g., PCI or CGI) of the first cell at the second network node 1104B, the UE 1102's C-RNTI at the first cell at the second network node 1104B, and a token. In some aspects, the token may be computed (e.g., determined) based on the cell ID (e.g., PCI) of the first cell at the second network node 1104B, the UE 1102's C-RNTI at the first cell at the second network node 1104B, and a CGI of the cell at the third network node. In some aspects, the second network node 1104B may attempt to identify and retrieve the UE context within a local database based on the cell ID (e.g., PCI or CGI) of the first cell at the second network node 1104B and the UE 1102's C-RNTI at the first cell at the second network node 1104B. In some aspects, if the second network node 1104B found the UE context, the second network node 1104B may re-establish RRC connection with the UE 1102 without involving the first network node 1104A. In some aspects, upon receiving the RRC re-establishment request message 1112 (e.g., if the second network node 1104B has not found the UE context), the second network node 1104B may, based on the stored mapping between (1) the cell ID (e.g., CGI or PCI) of the first cell at the second network node 1104B and the UE 1102's C-RNTI at the first cell at the second network node 1104B, and (2) an ID of the first network node 1104A, transmit a request to retrieve UE context 1114 to the first network node 1104A. In some aspects, after transmitting the request to retrieve UE context 1114 to the first network node 1104A, the second network node 1104B may receive a response 1116 from the first network node 1104A. In some aspects, the response 1116 may include a context of the UE 1102. After receiving the response 1116 that includes the context of the UE 1102, the second network node 1104B may attempt to re-establish RRC connection with the UE 1102 at 1120.

In some aspects, the request to retrieve UE context 1114 may include a PCI of the first cell at the second network node 1104B, the UE 1102's C-RNTI at the first cell at the second network node 1104B, a CGI of the cell at the third network node, and a token that may be computed based on the PCI of the first cell at the second network node 1104B, the UE 1102's C-RNTI at the first cell at the second network node 1104B. The first network node 1104A may be able to re-compute and verify the token based on the PCI of the first cell at the second network node 1104B and the UE 1102's C-RNTI at the first cell at the second network node 1104B.

In some aspects, to enable the first network node 1104A to not identify the request to retrieve UE context 1114 from the second network node 1104B as an error, the request to retrieve UE context 1114 may include an indication that the requested context is for a UE that experienced RLF while connected to a cell at the second network node 1104B with the first network node 1104A being the PDCP anchor. In some aspects, the indication may be an explicit flag. In some aspects, the indication may be an implicit indication based on the request being issued by the second network node 1104B towards the first network node 1104A, where the request includes a cell ID of the second network node 1104B for the last serving cell prior to RLF.

In some aspects, during the preparation, after receiving the identification information 1106 which includes the cell ID (e.g., CGI or PCI) of the first cell at the second network node 1104B and the UE 1102's C-RNTI at the first cell at the second network node 1104B, the first network node 1104A may store a mapping between (1) the UE context and (2) the cell ID (e.g., CGI or PCI) of the first cell at the second network node 1104B and the UE 1102's C-RNTI at the first cell at the second network node 1104B.

In some aspects, upon receiving the request to retrieve a UE context 1114, the first network node 1104A may retrieve the UE context based on the mapping between (1) the UE context and (2) the cell ID (e.g., CGI or PCI) of the first cell at the second network node 1104B and the UE 1102's C-RNTI at the first cell at the second network node 1104B.

In some aspects, to enable the first network node 1104A to retrieve the UE context upon receiving the request to retrieve the UE context 1114, the identification information 1106 may include an LTM session ID (or a configuration ID) associated with the UE 1102. In some aspects, the first network node 1104A may store a mapping between the LTM session ID (or the configuration ID) associated with the UE 1102 and the UE context for the UE 1102. The second network node 1104B may store a mapping between (1) the LTM session ID (or the configuration ID) and (2) the cell ID (e.g., CGI or PCI) of the first cell at the second network node 1104B and the UE 1102's C-RNTI at the first cell at the second network node 1104B. In some aspects, upon receiving the RRC re-establishment request message 1112 (which includes the cell ID (e.g., CGI or PCI) of the first cell at the second network node 1104B and the UE 1102's C-RNTI at the first cell at the second network node 1104B), based on the mapping, the second network node 1104B may include may include the LTM session ID (or the configuration ID) in the request to retrieve UE context 1114. Therefore, upon receiving the LTM session ID (or the configuration ID) in the request to retrieve UE context 1114, the first network node 1104A may be able to retrieve the UE context for the UE 1102 and transmit the UE context in the response 1116.

In some aspects, because the first network node may use a cell ID of the second network node and C-RNTI of a UE at the second network node to retrieve UE context, the second network node would transmit update of cell ID at the second network node and update of C-RNTI if an update others. Similarly, the second network node may transmit updates of other IDs that may be used in retrieving UE context.

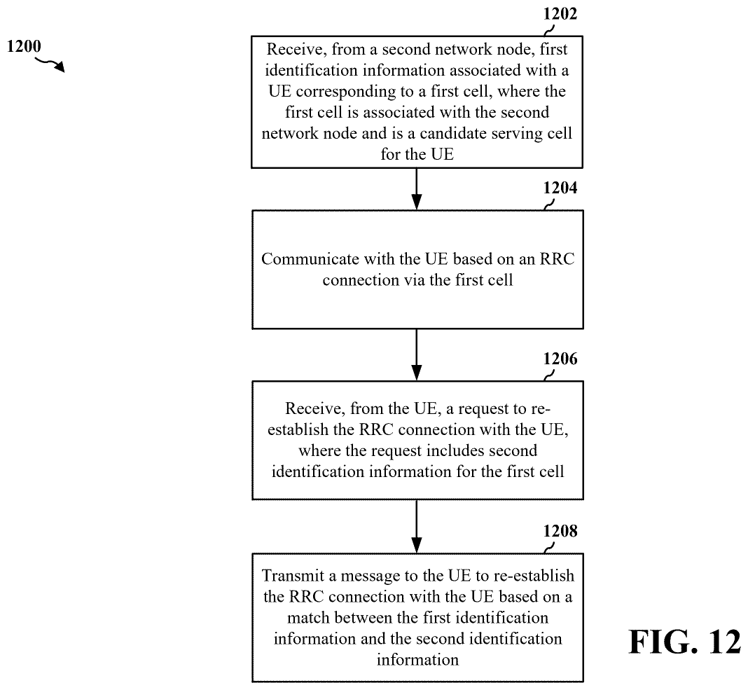

FIG. 12 is a flowchart 1200 of a method of wireless communication. The method may be performed by a first network node (e.g., the base station 102, the first network node 904A, the network entity 1602, the network entity 1602). The method may provide mechanisms for performing radio link failure recovery at the original PDCP anchor network node when the UE was originally anchored at separate network nodes for PDCP and RLC.

At 1202, the first network node may receive, from a second network node, first identification information associated with a UE corresponding to a first cell, where the first cell is associated with the second network node and is a candidate serving cell for the UE. For example, the first network node 904A may receive, from a second network node 904B, first identification information 906 associated with a UE 902 corresponding to a first cell, where the first cell is associated with the second network node 904B and is a candidate serving cell for the UE 902. In some aspects, 1202 may be performed by recovery component 199.

At 1204, the first network node may communicate with the UE based on an RRC connection via the first cell. For example, the first network node 904A may communicate with the UE 902 based on an RRC connection (e.g., at 908) via the first cell. In some aspects, 1204 may be performed by recovery component 199.

At 1206, the first network node may receive, from the UE, a request to re-establish the RRC connection with the UE, where the request includes second identification information for the first cell. For example, the first network node 904A may receive, from the UE, a request (e.g., 912) to re-establish the RRC connection with the UE, where the request includes second identification information for the first cell. In some aspects, 1206 may be performed by recovery component 199. In some aspects, the first identification information or the second identification information includes a cell identifier of the first cell and a scheduling identifier associated with the UE (e.g., 902), or a token based on the cell identifier and the scheduling identifier. In some aspects, the cell identifier is a PCI or a CGI of the first cell, and where the scheduling identifier is a C-RNTI associated with the UE at the first cell.

In some aspects, to receive the first identification information (e.g., 906), the first network node (e.g., 904A) may receive the first identification information (e.g., 906) before reception of the request (e.g., 912) to re-establish the RRC connection with the UE. In some aspects, to receive the first identification information (e.g., 906) before the reception of the request (e.g., 912) to re-establish the RRC connection with the UE, the first network node (e.g., 904A) may receive the first identification information (e.g., 906) before the reception of the request (e.g., 912) to re-establish the RRC connection with the UE (e.g., 902) in a configuration of the first cell for the UE.

In some aspects, to receive the first identification information (e.g., 906) before the reception of the request (e.g., 912) to re-establish the RRC connection with the UE, the first network node (e.g., 904A) may receive the first identification information (e.g., 906) before the reception of the request (e.g., 912) to re-establish the RRC connection with the UE (e.g., 902) in a dedicated signaling.

In some aspects, the first network node (e.g., 904A) may provide, to the second network node (e.g., 904B), a request (e.g., 914) to retrieve a context of the UE, where the request includes the second identification information.

In some aspects, the first network node (e.g., 904A) may receive a response (e.g., 916) to the request to retrieve the context of the UE, where the response includes an indication that indicates the RRC connection via the first cell or the first identification information or a presence (e.g., indicating the presence to be at the first network node 904A) of the context of the UE.

In some aspects, the first network node (e.g., 904A) may determine (e.g., after retrieval at 918) the match between the first identification information and the second identification information.

At 1208, the first network node may transmit a message to the UE to re-establish the RRC connection with the UE based on a match between the first identification information and the second identification information. For example, the first network node 904A may transmit a message (e.g., at 920) to the UE 902 to re-establish the RRC connection with the UE based on a match between the first identification information and the second identification information. In some aspects, 1208 may be performed by recovery component 199.

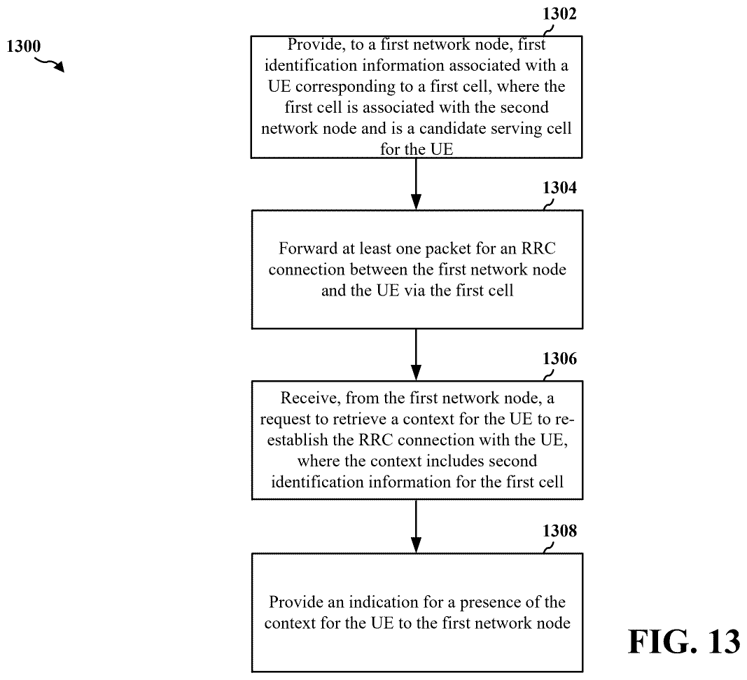

FIG. 13 is a flowchart 1300 of a method of wireless communication. The method may be performed by a second network node (e.g., the base station 102, the second network node 904B, the network entity 1602, the network entity 1602). The method may provide mechanisms for performing radio link failure recovery at the original PDCP anchor network node when the UE was originally anchored at separate network nodes for PDCP and RLC.

At 1302, the second network node may provide, to a first network node, first identification information associated with a UE corresponding to a first cell, where the first cell is associated with the second network node and is a candidate serving cell for the UE. For example, the second network node 904B may provide, to a first network node 904A, first identification information 906 associated with a UE 902 corresponding to a first cell, where the first cell is associated with the second network node 904B and is a candidate serving cell for the UE 902. In some aspects, 1302 may be performed by recovery component 199.

At 1304, the second network node may forward at least one packet for an RRC connection between the first network node and the UE via the first cell. For example, the second network node 904B may forward at least one packet for an RRC connection (at 908) between the first network node 904A and the UE 902 via the first cell. In some aspects, 1304 may be performed by recovery component 199.

At 1306, the second network node may receive, from the first network node, a request to retrieve a context for the UE to re-establish the RRC connection with the UE, where the context includes second identification information for the first cell. For example, the second network node 904B may receive, from the first network node 904A, a request (e.g., 914) to retrieve a context for the UE to re-establish the RRC connection with the UE 902, where the context includes second identification information for the first cell. In some aspects, 1306 may be performed by recovery component 199.

At 1308, the second network node may provide an indication for a presence of the context for the UE to the first network node. For example, the second network node 904B may provide an indication (e.g., 914) for a presence of the context for the UE to the first network node. In some aspects, 1308 may be performed by recovery component 199.

In some aspects, the first identification information or the second identification information includes a cell identifier of the first cell and a scheduling identifier associated with the UE (e.g., 902), or a token based on the cell identifier and the scheduling identifier. In some aspects, the cell identifier is a PCI or a CGI of the first cell, and where the scheduling identifier is a C-RNTI associated with the UE (e.g., 902) at the first cell. In some aspects, to provide the first identification information, the second network node (e.g., 906B) may provide the first identification information (e.g., 906) before forward (e.g., at 908) of the at least one packet. In some aspects, to provide the first identification information, the second network node (e.g., 906B) may provide the first identification information (e.g., 906) in a configuration of the first cell for the UE. In some aspects, to provide the first identification information, the second network node (e.g., 906B) may provide the first identification information (e.g., 906) in a dedicated signaling. In some aspects, the indication (e.g., 916) indicates the RRC connection (e.g., 908) via the first cell or the first identification information. In some aspects, the first cell is an LTM cell, and where the at least one packet includes a PDU of the RRC connection or a UP PDU via a bearer configured using the RRC connection.

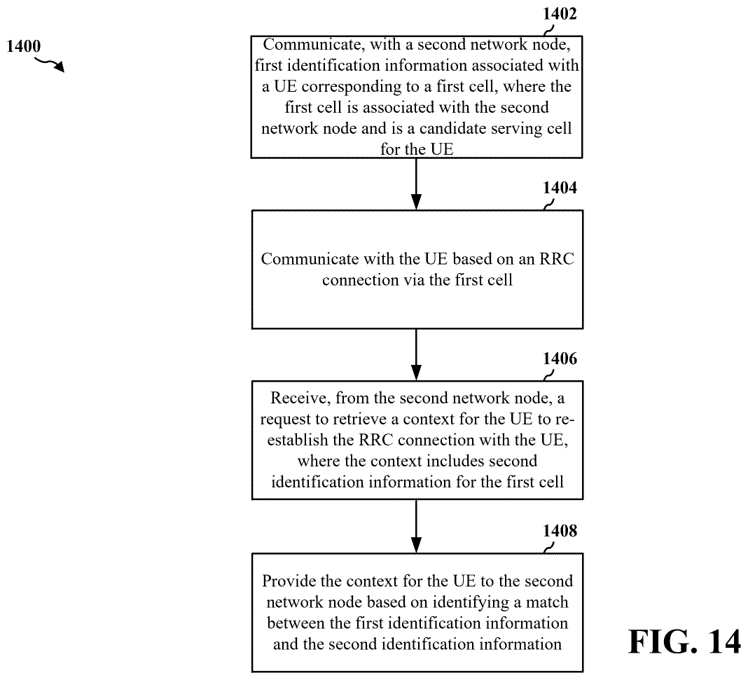

FIG. 14 is a flowchart 1400 of a method of wireless communication. The method may be performed by a first network node (e.g., the base station 102, the first network node 1104A, the network entity 1602, the network entity 1602). The method may provide mechanisms for performing radio link failure recovery at the original RLC anchor network node when the UE was originally anchored at separate network nodes for PDCP and RLC.

At 1402, the first network node may communicate, with a second network node, first identification information associated with a UE corresponding to a first cell, where the first cell is associated with the second network node and is a candidate serving cell for the UE. For example, the first network node 1104A may communicate, with a second network node 1104B, first identification information 1106 associated with a UE 1102 corresponding to a first cell, where the first cell is associated with the second network node 1104B and is a candidate serving cell for the UE 1102. In some aspects, 1402 may be performed by recovery component 199.

At 1404, the first network node may communicate with the UE based on an RRC connection via the first cell. For example, the first network node 1104A may communicate with the UE based on an RRC connection (e.g., at 1108) via the first cell. In some aspects, 1404 may be performed by recovery component 199.

At 1406, the first network node may receive, from the second network node, a request to retrieve a context for the UE to re-establish the RRC connection with the UE, where the context includes second identification information for the first cell. For example, the first network node 1104A may receive, from the second network node 1104B, a request (e.g., 1114) to retrieve a context for the UE to re-establish the RRC connection with the UE, where the context includes second identification information for the first cell. In some aspects, 1406 may be performed by recovery component 199.

At 1408, the first network node may provide the context for the UE to the second network node based on identifying a match between the first identification information and the second identification information. For example, the first network node 1104A may provide the context (e.g., 1116) for the UE to the second network node based on identifying a match between the first identification information and the second identification information. In some aspects, 1408 may be performed by recovery component 199.

In some aspects, the first identification information (e.g., 1106) or the second identification information (e.g., in 1114) includes a cell identifier of the first cell and a scheduling identifier associated with the UE (e.g., 1102), a token based on the cell identifier and the scheduling identifier, or an LTM session identifier. In some aspects, the cell identifier is a PCI or a CGI of the first cell, and where the scheduling identifier is a C-RNTI associated with the UE (e.g., 1102) at the first cell.

In some aspects, to receive the first identification information (e.g., 1106), the first network node (e.g., 1104A) may receive the first identification information (e.g., 1106) before an RLF (e.g., 1110) of the RRC connection with the UE 1102. In some aspects, to receive the first identification information (e.g., 1106) before the RLF (e.g., 1110) of the RRC connection with the UE (e.g., 1102), the first network node (e.g., 1104A) may receive the first identification information (e.g., 1106) before the RLF (e.g., 1110) of the RRC connection with the UE (e.g., 1102) in a configuration of the first cell for the UE. In some aspects, to receive the first identification information (e.g., 1106) before the RLF (e.g., 1110) of the RRC connection with the UE (e.g., 1102), the first network node (e.g., 1104A) may receive the first identification information (e.g., 1106) before the RLF (e.g., 1110) of the RRC connection with the UE (e.g., 1102) in a dedicated signaling.

In some aspects, the request (e.g., 1114) to retrieve the context for the UE includes an indication of the RRC connection, where the indication includes at least one of: a flag that indicates a presence of the RRC connection, an identifier of the first cell, an LTM session ID, or a configuration ID associated with the RRC connection (e.g., 1108). In some aspects, the first cell is an LTM cell.

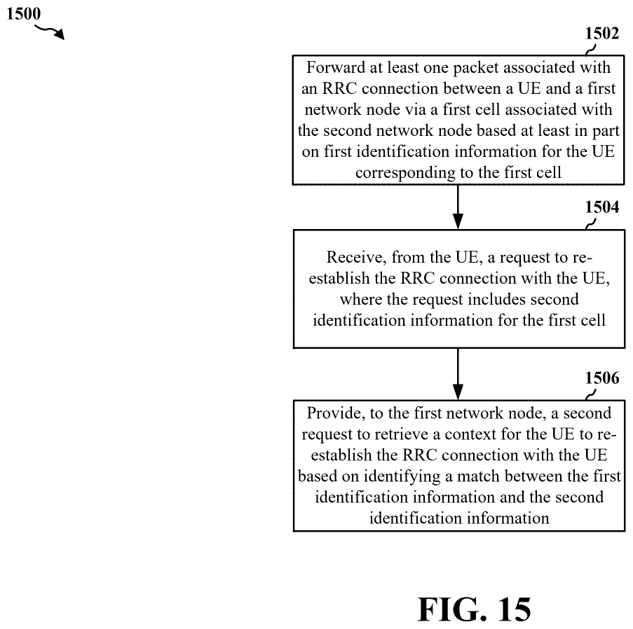

FIG. 15 is a flowchart 1500 of a method of wireless communication. The method may be performed by a second network node (e.g., the base station 102, the second network node 1104B, the network entity 1602, the network entity 1602). The method may provide mechanisms for performing radio link failure recovery at the original RLC anchor network node when the UE was originally anchored at separate network nodes for PDCP and RLC.

At 1502, the second network node may forward at least one packet associated with an RRC connection between a UE and a first network node via a first cell associated with the second network node based at least in part on first identification information for the UE corresponding to the first cell. For example, the second network node 1104B may forward at least one packet associated with an RRC connection (e.g., 1108) between a UE and a first network node via a first cell associated with the second network node based at least in part on first identification information for the UE corresponding to the first cell. In some aspects, 1502 may be performed by recovery component 199.

At 1504, the second network node may receive, from the UE, a request to re-establish the RRC connection with the UE, where the request includes second identification information for the first cell. For example, the second network node 1104B may receive, from the UE 1102, a request (e.g., 1112) to re-establish the RRC connection with the UE 1102, where the request includes second identification information for the first cell. In some aspects, 1504 may be performed by recovery component 199.

At 1506, the second network node may provide, to the first network node, a second request to retrieve a context for the UE to re-establish the RRC connection with the UE based on identifying a match between the first identification information and the second identification information. For example, the second network node 1104B may provide, to the first network node 1104A, a second request (e.g., 1114) to retrieve a context for the UE to re-establish the RRC connection with the UE 1102 based on identifying a match between the first identification information and the second identification information. In some aspects, 1506 may be performed by recovery component 199.

In some aspects, the first identification information (e.g., 1106) or the second identification information (e.g., in 1114) includes a cell identifier of the first cell and a scheduling identifier associated with the UE (e.g., 1102), a token based on the cell identifier and the scheduling identifier, or an LTM session identifier. In some aspects, the cell identifier is a PCI or a CGI of the first cell, and where the scheduling identifier is a C-RNTI associated with the UE (e.g., 1102) at the first cell.

In some aspects, the second network node (e.g., 1104B) may provide the first identification information (e.g., 1106) to the first network node (e.g., 1104A) before forward (e.g., at 1108) of the least one packet. In some aspects, to provide the first identification information (e.g., 1106) before forward (e.g., at 1108) of the least one packet, the second network node (e.g., 1104B) may provide the first identification information (e.g., 1106) in a configuration of the first cell for the UE (e.g., 1102). In some aspects, to provide the first identification information (e.g., 1106) before forward (e.g., at 1108) of the least one packet, the second network node (e.g., 1104B) may provide the first identification information (e.g., 1106) in a dedicates signaling. In some aspects, the request (e.g., 1114) to retrieve the context for the UE includes an indication of the RRC connection (e.g., 1108), where the indication includes at least one of: a flag that indicates a presence (e.g., indicating the presence to be at the first network node 1104A) of the RRC connection, an identifier of the first cell, an LTM session ID, or a configuration ID associated with the RRC connection. In some aspects, the first cell is an LTM cell, and where the at least one packet includes a PDU of the RRC connection or a UP PDU via a bearer configured using the RRC connection.

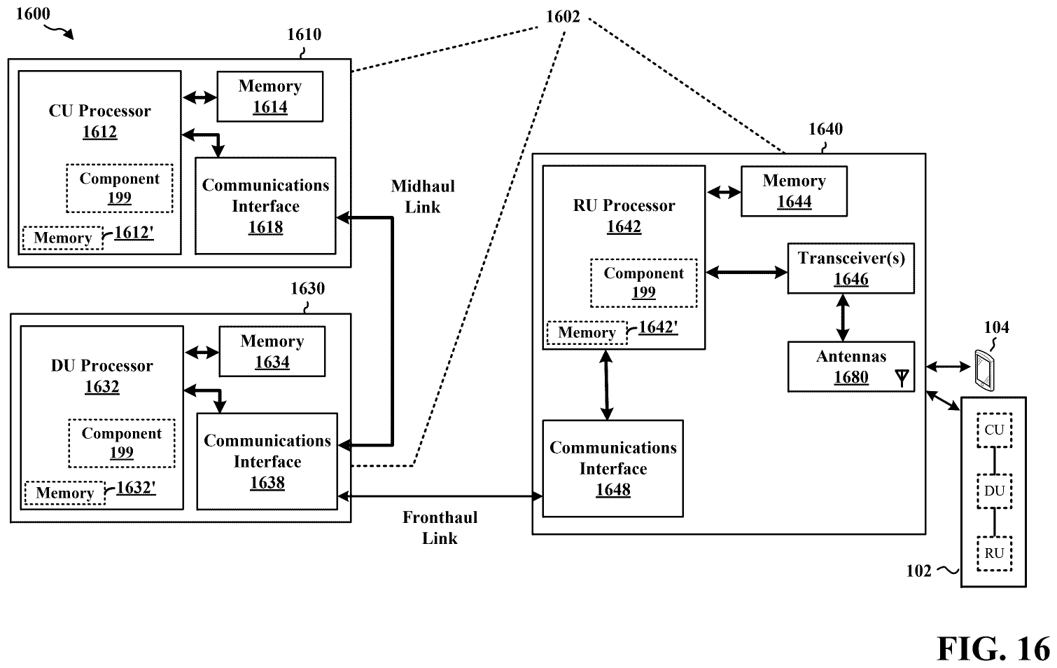

FIG. 16 is a diagram 1600 illustrating an example of a hardware implementation for a network entity 1602. The network entity 1602 may be a BS, a component of a BS, or may implement BS functionality. The network entity 1602 may be the first network node or the second network node. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the recovery component 199 may be configured to receive, from a second network node, first identification information associated with a UE corresponding to a first cell, where the first cell is associated with the second network node and is a candidate serving cell for the UE. In some aspects, the recovery component 199 may be configured to communicate with the UE based on an RRC connection via the first cell. In some aspects, the recovery component 199 may be configured to receive, from the UE, a request to re-establish the RRC connection with the UE, where the request includes second identification information for the first cell. In some aspects, the recovery component 199 may be configured to transmit a message to the UE to re-establish the RRC connection with the UE based on a match between the first identification information and the second identification information.

In some aspects, the recovery component 199 may be configured to provide, to a first network node, first identification information associated with a UE corresponding to a first cell, where the first cell is associated with the second network node and is a candidate serving cell for the UE. In some aspects, the recovery component 199 may be configured to forward at least one packet for an RRC connection between the first network node and the UE via the first cell. In some aspects, the recovery component 199 may be configured to receive, from the first network node, a request to retrieve a context for the UE to re-establish the RRC connection with the UE, where the context includes second identification information for the first cell. In some aspects, the recovery component 199 may be configured to provide an indication for a presence of the context for the UE to the first network node.

In some aspects, the recovery component 199 may be configured to communicate, with a second network node, first identification information associated with a UE corresponding to a first cell, where the first cell is associated with the second network node and is a candidate serving cell for the UE. In some aspects, the recovery component 199 may be configured to communicate with the UE based on an RRC connection via the first cell. In some aspects, the recovery component 199 may be configured to receive, from the second network node, a request to retrieve a context for the UE to re-establish the RRC connection with the UE, where the context includes second identification information for the first cell. In some aspects, the recovery component 199 may be configured to provide the context for the UE to the second network node based on identifying a match between the first identification information and the second identification information.

In some aspects, the recovery component 199 may be configured to forward at least one packet associated with an RRC connection between a UE and a first network node via a first cell associated with the second network node based at least in part on first identification information for the UE corresponding to the first cell. In some aspects, the recovery component 199 may be configured to receive, from the UE, a request to re-establish the RRC connection with the UE, where the request includes second identification information for the first cell. In some aspects, the recovery component 199 may be configured to provide, to the first network node, a second request to retrieve a context for the UE to re-establish the RRC connection with the UE based on identifying a match between the first identification information and the second identification information. The component 199 and/or another component of the network entity 1602 can be configured to perform any of the aspects described in connection with the flowchart in FIG. 12-15 and/or performed by the first network node or the second network node in the communication flow in FIG. 11.

The recovery component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In some aspects, the network entity 1602 may include means for receiving, from a second network node, first identification information associated with a UE corresponding to a first cell, where the first cell is associated with the second network node and is a candidate serving cell for the UE. In some aspects, the network entity 1602 may include means for communicating with the UE based on an RRC connection via the first cell. In some aspects, the network entity 1602 may include means for receiving, from the UE, a request to re-establish the RRC connection with the UE, where the request includes second identification information for the first cell. In some aspects, the network entity 1602 may include means for transmitting a message to the UE to re-establish the RRC connection with the UE based on a match between the first identification information and the second identification information. In some aspects, the network entity 1602 may include means for receiving the first identification information before reception of the request to re-establish the RRC connection with the UE. In some aspects, the network entity 1602 may include means for receiving the first identification information before the reception of the request to re-establish the RRC connection with the UE in a configuration of the first cell for the UE. In some aspects, the network entity 1602 may include means for receiving the first identification information before the reception of the request to re-establish the RRC connection with the UE in a dedicated signaling. In some aspects, the network entity 1602 may include means for providing, to the second network node, a request to retrieve a context of the UE, where the request includes the second identification information. In some aspects, the network entity 1602 may include means for receiving a response to the request to retrieve the context of the UE, where the response includes an indication that indicates the RRC connection via the first cell or the first identification information or a presence of the context of the UE. In some aspects, the network entity 1602 may include means for determining the match between the first identification information and the second identification information. In some aspects, the network entity 1602 may include means for providing, to a first network node, first identification information associated with a UE corresponding to a first cell, where the first cell is associated with the second network node and is a candidate serving cell for the UE. In some aspects, the network entity 1602 may include means for forwarding at least one packet for an RRC connection between the first network node and the UE via the first cell. In some aspects, the network entity 1602 may include means for receiving, from the first network node, a request to retrieve a context for the UE to re-establish the RRC connection with the UE, where the context includes second identification information for the first cell. In some aspects, the network entity 1602 may include means for providing an indication for a presence of the context for the UE to the first network node. In some aspects, the network entity 1602 may include means for providing the first identification information before forwarding of the at least one packet. In some aspects, the network entity 1602 may include means for providing the first identification information in a configuration of the first cell for the UE. In some aspects, the network entity 1602 may include means for providing the first identification information in a dedicated signaling. In some aspects, the network entity 1602 may include means for communicating, with a second network node, first identification information associated with a UE corresponding to a first cell, where the first cell is associated with the second network node and is a candidate serving cell for the UE. In some aspects, the network entity 1602 may include means for communicating with the UE based on an RRC connection via the first cell. In some aspects, the network entity 1602 may include means for receiving, from the second network node, a request to retrieve a context for the UE to re-establish the RRC connection with the UE, where the context includes second identification information for the first cell. In some aspects, the network entity 1602 may include means for providing the context for the UE to the second network node based on identifying a match between the first identification information and the second identification information. In some aspects, the network entity 1602 may include means for receiving the first identification information before an RLF of the RRC connection with the UE. In some aspects, the network entity 1602 may include means for receiving the first identification information before the RLF of the RRC connection with the UE in a configuration of the first cell for the UE. In some aspects, the network entity 1602 may include means for receiving the first identification information before the RLF of the RRC connection with the UE in a dedicated signaling. In some aspects, the network entity 1602 may include means for forwarding at least one packet associated with an RRC connection between a UE and a first network node via a first cell associated with the second network node based at least in part on first identification information for the UE corresponding to the first cell. In some aspects, the network entity 1602 may include means for receiving, from the UE, a request to re-establish the RRC connection with the UE, where the request includes second identification information for the first cell. In some aspects, the network entity 1602 may include means for providing, to the first network node, a second request to retrieve a context for the UE to re-establish the RRC connection with the UE based on identifying a match between the first identification information and the second identification information. In some aspects, the network entity 1602 may include means for providing the first identification information to the first network node before forwarding of the least one packet. In some aspects, the network entity 1602 may include means for providing the first identification information in a configuration of the first cell for the UE. In some aspects, the network entity 1602 may include means for providing the first identification information in a dedicated signaling. The means may be the component 199 of the network entity 1602 configured to perform the functions recited by the means. The means may be for performing any of the aspects described in connection with the flowchart in FIG. 12-15 and/or performed by the first network node or the second network node in the communication flow in FIG. 11. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for communication at a first network node, including: at least one memory; and at least one processor coupled to the at least one memory and, based at least in part on information stored in the at least one memory, the at least one processor is configured to: receive, from a second network node, first identification information associated with a user equipment (UE) corresponding to a first cell, where the first cell is associated with the second network node and is a candidate serving cell for the UE; communicate with the UE based on a radio resource control (RRC) connection via the first cell; receive, from the UE, a request to re-establish the RRC connection with the UE, where the request includes second identification information for the first cell; and transmit a message to the UE to re-establish the RRC connection with the UE based on a match between the first identification information and the second identification information.

Aspect 2 is the apparatus of aspect 1, where the first identification information or the second identification information includes a cell identifier of the first cell and a scheduling identifier associated with the UE, or a token based on the cell identifier and the scheduling identifier.

Aspect 3 is the apparatus of aspect 2, where the cell identifier is a physical cell identifier (PCI) or a cell global identifier (CGI) of the first cell, and where the scheduling identifier is a cell radio network temporary identifier (C-RNTI) associated with the UE at the first cell.

Aspect 4 is the apparatus of any of aspects 1-3, where to receive the first identification information, the at least one processor is configured to: receive the first identification information before reception of the request to re-establish the RRC connection with the UE.

Aspect 5 is the apparatus of aspect 4, where to receive the first identification information before the reception of the request to re-establish the RRC connection with the UE, the at least one processor is configured to: receive the first identification information before the reception of the request to re-establish the RRC connection with the UE in a configuration of the first cell for the UE.

Aspect 6 is the apparatus of any of aspects 4-5, where to receive the first identification information before the reception of the request to re-establish the RRC connection with the UE, the at least one processor is configured to: receive the first identification information before the reception of the request to re-establish the RRC connection with the UE in a dedicated signaling.

Aspect 7 is the apparatus of any of aspects 1-6, where the at least one processor is configured to: provide, to the second network node, a request to retrieve a context of the UE, where the request includes the second identification information; and receive a response to the request to retrieve the context of the UE, where the response includes an indication that indicates the RRC connection via the first cell or the first identification information or a presence of the context of the UE.

Aspect 8 is the apparatus of any of aspects 1-7, where the first cell is a lower-layer triggered mobility (LTM) cell.

Aspect 9 is the apparatus of any of aspects 1-8, where the at least one processor is configured to: determine the match between the first identification information and the second identification information.

Aspect 10 is an apparatus for communication at a second network node, including: at least one memory; and at least one processor coupled to the at least one memory and, based at least in part on information stored in the at least one memory, the at least one processor is configured to: provide, to a first network node, first identification information associated with a user equipment (UE) corresponding to a first cell, where the first cell is associated with the second network node and is a candidate serving cell for the UE; forward at least one packet for a radio resource control (RRC) connection between the first network node and the UE via the first cell; receive, from the first network node, a request to retrieve a context for the UE to re-establish the RRC connection with the UE, where the context includes second identification information for the first cell; and provide an indication for a presence of the context for the UE to the first network node.

Aspect 11 is the apparatus of aspect 10, where the first identification information or the second identification information includes a cell identifier of the first cell and a scheduling identifier associated with the UE, or a token based on the cell identifier and the scheduling identifier.

Aspect 12 is the apparatus of aspect 11, where the cell identifier is a physical cell identifier (PCI) or a cell global identifier (CGI) of the first cell, and where the scheduling identifier is a cell radio network temporary identifier (C-RNTI) associated with the UE at the first cell.

Aspect 13 is the apparatus of any of aspects 10-12, where to provide the first identification information, the at least one processor is configured to: provide the first identification information before forward of the at least one packet.

Aspect 14 is the apparatus of aspect 13, where to provide the first identification information before the forward of the at least one packet, the at least one processor is configured to: provide the first identification information in a configuration of the first cell for the UE.

Aspect 15 is the apparatus of any of aspects 13-14, where to provide the first identification information before the forward of the at least one packet, the at least one processor is configured to: provide the first identification information in a dedicated signaling.

Aspect 16 is the apparatus of any of aspects 10-15, where the indication indicates the RRC connection via the first cell or the first identification information.

Aspect 17 is the apparatus of any of aspects 10-16, where the first cell is a lower-layer triggered mobility (LTM) cell, and where the at least one packet includes a protocol data unit (PDU) of the RRC connection or a user plane PDU (UP PDU) via a bearer configured using the RRC connection.

Aspect 18 is an apparatus for communication at a first network node, including: at least one memory; and at least one processor coupled to the at least one memory and, based at least in part on information stored in the at least one memory, the at least one processor is configured to: communicate, with a second network node, first identification information associated with a user equipment (UE) corresponding to a first cell, where the first cell is associated with the second network node and is a candidate serving cell for the UE; communicate with the UE based on a radio resource control (RRC) connection via the first cell; receive, from the second network node, a request to retrieve a context for the UE to re-establish the RRC connection with the UE, where the context includes second identification information for the first cell; and provide the context for the UE to the second network node based on identifying a match between the first identification information and the second identification information.

Aspect 19 is the apparatus of aspect 18, where the first identification information or the second identification information includes a cell identifier of the first cell and a scheduling identifier associated with the UE, a token based on the cell identifier and the scheduling identifier, or a lower-layer triggered mobility (LTM) session identifier.

Aspect 20 is the apparatus of aspect 19, where the cell identifier is a physical cell identifier (PCI) or a cell global identifier (CGI) of the first cell, and where the scheduling identifier is a cell radio network temporary identifier (C-RNTI) associated with the UE at the first cell.

Aspect 21 is the apparatus of any of aspects 18-20, where to receive the first identification information, the at least one processor is configured to: receive the first identification information before a radio link failure (RLF) of the RRC connection.

Aspect 22 is the apparatus of aspect 21, where to receive the first identification information before the RLF of the RRC connection with the UE, the at least one processor is configured to: receive the first identification information before the RLF of the RRC connection in a configuration of the first cell for the UE.

Aspect 23 is the apparatus of any of aspects 21-22, where to receive the first identification information before the RLF of the RRC connection with the UE, the at least one processor is configured to: receive the first identification information before the RLF of the RRC connection with the UE in a dedicated signaling.

Aspect 24 is the apparatus of any of aspects 18-23, where the request to retrieve the context for the UE includes an indication of the RRC connection, where the indication includes at least one of: a flag that indicates a presence of the RRC connection, an identifier of the first cell, a lower-layer triggered mobility (LTM) session ID, or a configuration ID associated with the RRC connection.

Aspect 25 is the apparatus of any of aspects 18-24, where the first cell is a lower-layer triggered mobility (LTM) cell.

Aspect 26 is an apparatus for communication at a second network node, including: at least one memory; and at least one processor coupled to the at least one memory and, based at least in part on information stored in the at least one memory, the at least one processor is configured to: forward at least one packet associated with a radio resource control (RRC) connection between a user equipment (UE) and a first network node via a first cell associated with the second network node based at least in part on first identification information for the UE corresponding to the first cell; receive, from the UE, a request to re-establish the RRC connection with the UE, where the request includes second identification information for the first cell; and provide, to the first network node, a second request to retrieve a context for the UE to re-establish the RRC connection with the UE based on identifying a match between the first identification information and the second identification information.

Aspect 27 is the apparatus of aspect 26, where the first identification information or the second identification information includes a cell identifier of the first cell and a scheduling identifier associated with the UE, a token based on the cell identifier and the scheduling identifier, or a lower-layer triggered mobility (LTM) session identifier.

Aspect 28 is the apparatus of aspect 27, where the cell identifier is a physical cell identifier (PCI) or a cell global identifier (CGI) of the first cell, and where the scheduling identifier is a cell radio network temporary identifier (C-RNTI) associated with the UE at the first cell.

Aspect 29 is the apparatus of any of aspects 26-28, where the at least one processor is further configured to: provide the first identification information to the first network node before forward of the at least one packet.

Aspect 30 is the apparatus of aspect 29, where to provide the first identification information before the forward of the at least one packet, the at least one processor is configured to: provide the first identification information in a configuration of the first cell for the UE.

Aspect 31 is the apparatus of any of aspects 29-30, where to provide the first identification information before the forward of the at least one packet, the at least one processor is configured to: provide the first identification information in a dedicated signaling.

Aspect 32 is the apparatus of any of aspects 26-31, where the request to retrieve the context for the UE includes an indication of the RRC connection, where the indication includes at least one of: a flag that indicates a presence of the RRC connection, an identifier of the first cell, a lower-layer triggered mobility (LTM) session ID, or a configuration ID associated with the RRC connection.

Aspect 33 is the apparatus of any of aspects 26-32, where the first cell is a lower-layer triggered mobility (LTM) cell, and where the at least one packet includes a protocol data unit (PDU) of the RRC connection or a user plane PDU (UP PDU) via a bearer configured using the RRC connection.

Aspect 34 is a method of wireless communication for implementing any of aspects 1 to 33.

Aspect 35 is a computer-readable medium (e.g., a non-transitory computer-readable medium) storing computer executable code, the code when executed by at least one processor causes the at least one processor to implement any of aspects 1 to 33.

Aspect 36 is an apparatus comprising means for implementing any of aspects 1 to 33.

What is claimed is:

1. An apparatus for communication at a first network node, comprising:
at least one memory; and
at least one processor coupled to the at least one memory and, based at least in part on information stored in the at least one memory, the at least one processor is configured to:
receive, from a second network node, first identification information associated with a user equipment (UE) corresponding to a first cell, wherein the first cell is associated with the second network node and is a candidate serving cell for the UE;
communicate with the UE based on a radio resource control (RRC) connection via the first cell;
receive, from the UE, a request to re-establish the RRC connection with the UE, wherein the request comprises second identification information for the first cell; and
transmit a message to the UE to re-establish the RRC connection with the UE based on a match between the first identification information and the second identification information.

2. The apparatus of claim 1, wherein the first identification information or the second identification information comprises a cell identifier of the first cell and a scheduling identifier associated with the UE, or a token based on the cell identifier and the scheduling identifier.

3. The apparatus of claim 2, wherein the cell identifier is a physical cell identifier (PCI) or a cell global identifier (CGI) of the first cell, and wherein the scheduling identifier is a cell radio network temporary identifier (C-RNTI) associated with the UE at the first cell.

4. The apparatus of claim 1, wherein to receive the first identification information, the at least one processor is configured to:
receive the first identification information before reception of the request to re-establish the RRC connection with the UE.

5. The apparatus of claim 4, wherein to receive the first identification information before the reception of the request to re-establish the RRC connection with the UE, the at least one processor is configured to:
receive the first identification information before the reception of the request to re-establish the RRC connection with the UE in a configuration of the first cell for the UE.

6. The apparatus of claim 4, wherein to receive the first identification information before the reception of the request to re-establish the RRC connection with the UE, the at least one processor is configured to:
receive the first identification information before the reception of the request to re-establish the RRC connection with the UE in a dedicated signaling.

7. The apparatus of claim 1, wherein the at least one processor is configured to:
provide, to the second network node, a request to retrieve a context of the UE, wherein the request comprises the second identification information; and
receive a response to the request to retrieve the context of the UE, wherein the response comprises an indication that indicates the RRC connection via the first cell or the first identification information or a presence of the context of the UE.

8. The apparatus of claim 1, wherein the first cell is a lower-layer triggered mobility (LTM) cell.

9. The apparatus of claim 1, wherein the at least one processor is configured to:
determine the match between the first identification information and the second identification information.

10. An apparatus for communication at a second network node, comprising:
at least one memory; and
at least one processor coupled to the at least one memory and, based at least in part on information stored in the at least one memory, the at least one processor is configured to:
forward at least one packet associated with a radio resource control (RRC) connection between a user equipment (UE) and a first network node via a first cell associated with the second network node based at least in part on first identification information for the UE corresponding to the first cell;
receive, from the UE, a request to re-establish the RRC connection with the UE, wherein the request comprises second identification information for the first cell; and
provide, to the first network node, a second request to retrieve a context for the UE to re-establish the RRC connection with the UE based on identifying a match between the first identification information and the second identification information.

11. The apparatus of claim 10, wherein the first identification information or the second identification information comprises a cell identifier of the first cell and a scheduling identifier associated with the UE, a token based on the cell identifier and the scheduling identifier, or a lower-layer triggered mobility (LTM) session identifier.

12. The apparatus of claim 11, wherein the cell identifier is a physical cell identifier (PCI) or a cell global identifier (CGI) of the first cell, and wherein the scheduling identifier is a cell radio network temporary identifier (C-RNTI) associated with the UE at the first cell.

13. The apparatus of claim 10, wherein the at least one processor is further configured to:
provide the first identification information to the first network node before forward of the at least one packet.

14. The apparatus of claim 13, wherein to provide the first identification information before the forward of the at least one packet, the at least one processor is configured to:
provide the first identification information in a configuration of the first cell for the UE.

15. The apparatus of claim 13, wherein to provide the first identification information before the forward of the at least one packet, the at least one processor is configured to:
provide the first identification information in a dedicated signaling.

16. The apparatus of claim 10, wherein the request to retrieve the context for the UE comprises an indication of the RRC connection, wherein the indication comprises at least one of: a flag that indicates a presence of the RRC connection, an identifier of the first cell, a lower-layer triggered mobility (LTM) session ID, or a configuration ID associated with the RRC connection.

17. The apparatus of claim 10, wherein the first cell is a lower-layer triggered mobility (LTM) cell, and wherein the at least one packet comprises a protocol data unit (PDU) of the RRC connection or a user plane PDU (UP PDU) via a bearer configured using the RRC connection.

18. A method for communication performed by a first network node, comprising:
receiving, from a second network node, first identification information associated with a user equipment (UE) corresponding to a first cell, wherein the first cell is associated with the second network node and is a candidate serving cell for the UE;
communicating with the UE based on a radio resource control (RRC) connection via the first cell;
receiving, from the UE, a request to re-establish the RRC connection with the UE, wherein the request comprises second identification information for the first cell; and
transmitting a message to the UE to re-establish the RRC connection with the UE based on a match between the first identification information and the second identification information.

19. The method of claim 18, wherein the first identification information or the second identification information comprises a cell identifier of the first cell and a scheduling identifier associated with the UE, or a token based on the cell identifier and the scheduling identifier.

20. The method of claim 19, wherein the cell identifier is a physical cell identifier (PCI) or a cell global identifier (CGI) of the first cell, and wherein the scheduling identifier is a cell radio network temporary identifier (C-RNTI) associated with the UE at the first cell.
